(19) United States
(12) Patent Application Publication
(10) Pub. No.: US 2002/0054081 A1
(43) Pub. Date: May 9, 2002

(54) Procedure for the creation of a control interface for a standard application in a computer network browser

(76) Inventor: Ralf Mimoun, Koeln (DE)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 09/883,150

(22) Filed: Jun. 15, 2001

(30) Foreign Application Priority Data
Jun. 15, 2000 (DE) DE 100 28 842.1

(51) Int. Cl. G09G 5/00

(52) U.S. Cl. 345/738

(57) ABSTRACT

Software for creating a user interface for a standard application in a browser window of a personal computer workstation on a computer network is integrated in the standard application. The standard application runs on a server and at least one user works through the network with the standard application, which is shown on the user's personal computer workstation and which can be serviced remotely. The work result is subsequently returned to the standard application. The method is implemented in such a way that the software module can return the separate components of the user interface of the standard application to the browser of the personal computer workstation. The software module converts the state and the function of the components into standard code that can be interpreted by the browser and transfers to the standard application in the requested format the user's data returned by the browser.

### RELATED APPLICATIONS

This application claims priority under the Paris Convention based on German Patent Application No. DE 100 38 842.1 filed Jun. 15, 2000.

### BACKGROUND OF THE INVENTION

1. Field of the Invention

The invention relates generally to the use of standard applications over a computer network and, more particularly to a software for, and a method of creating a user interface for a standard application in the window of a browser, which runs on a personal computer workstation within a computer network, particularly within an Intranet or an Internet. The standard application runs on a server connected to the computer network and at least one user works on the personal computer workstation through the network. The standard application can be run by means of a user interface and, if necessary, the output of the standard application can be returned by means of the output fields of the user interface.

2. Description of the Related Art

Several methods and software exist which relate to the use of standard applications over a computer network. Such known software often requires the installation of a special client software on the user side. One such method is known from the application of the “Citrix™ Metaframe” software. This software is known from the manual “Feature Guide for Citrix™ MetaFrame for Windows 2000 Servers”, which can be obtained through the Internet home page of the firm Citrix Systems Inc., Fort Lauderdale, Fla. 33309, USA (http://www.citrix.com). It contains a classical client/server management system, whereby various additional modules are necessary, for instance the so-called “Application Server”, which makes it possible to distribute the applications, as well as special client software at the personal computer workstation. Because of that it is not suitable to be used for servicing software by any web browser.

Another known software for the implementation of a generic method is “GraphOn Bridges™” of the firm GraphOn Corp., Cambell, Calif. 95008, USA (http://www.graphon.com), described in the manual “Bridges™ Product Sheet”, which can be obtained through the Internet home page of the manufacturer. This software runs on a server, whereby the content of the window is further redirected to special client software. Also, Bridges™ does not evaluate the structure of the application window, but redirects further to the client software the API calls of the operating system for drawing the window content.

A programmer of a standard application can further implement an application as so-called ActiveX™ control. This ActiveX™ control is a program file that can be run on personal computer workstations with the Microsoft Windows™ operating system instead of the standard application. In the praxis however, this means that the whole program has to be transferred and presented in the browser window, whereby, since no HTML code can be created, the program becomes dependent on the operating system of the personal computer workstation at the browser side.

Hence, those skilled in the art have recognized a need for providing a method and software that permit an easy presentation of the user interface of a standard application as well as servicing the standard application through the browser without any requirements to the personal computer workstation and the browser that is installed on it. The invention fulfills these needs and others.

### SUMMARY OF THE INVENTION

Briefly, and in general terms, the invention is directed to a method and software that permit an easy presentation of the user interface of a standard application as well as servicing the standard application through the browser without any requirements to the personal computer workstation and the browser that is installed on it.

According to the invention, this objective is achieved in such a way that a software module is integrated into the standard application and this module permits to reproduce on the browser of the personal computer workstation the separate components of the user interface of the standard application. Whereby the software module transforms the state and the function of the components into standard code which is then interpreted by the browser. The user data returned by the browser are transferred to the standard application in the required format.

In one aspect, the invention relates to a method for creating a user interface for a standard application in the window of a browser that runs on a personal computer workstation of a computer network, such as an Intranet or the Internet. The standard application runs on a server connected to a computer network. At least one user works with the standard application from the personal computer workstation over the computer network. The standard application can be serviced by means of a user interface and also occasionally some work results from the standard application can be returned through the output fields of the user interface. A software module is integrated into the standard application. This module can present separate components of the user interface of the standard application in the browser of the personal computer workstation. The software module converts the state and the function of the components into standard code that can be interpreted by the browser and transfers to the standard application in the requested format the data entered by the user and returned by the browser.

In a detailed aspect, the separate components include list boxes, input fields and/or output fields. In another detailed aspect, the software module interprets as graphic the components it does not recognize and presents in the browser window the information for drawing the corresponding graphical components and returns to the server the information about the user input corresponding to the graphical components. In additional detailed facets, the software module produces either HTML code or XML code.

In another aspect, the size, color, and in the case of text components, the type face and font size of the components on the user interface of the standard application are investigated and transferred to the browser, along with the coordinates of the components. In other aspects, the software module investigates the coordinates of the position of every component on the user interface and on the basis of these co-ordinates it draws the components in the browser in a manner that is identical or similar to their positioning on the user interface of the standard application. Alternatively, the software module investigates the components of the user interface and their positioning on a copy of the user interface of the standard application and generates code that is needed in order to draw in the browser such components that are identical or similar to the investigated components.

In another detailed facet, the server runs management software, which—on request by the user through the browser—starts a desired standard application from among the standard applications available on the server and organizes and manages the transfer between the server and the personal computer workstation. The server has management software installed can be called by other servers either directly or through a suitable interface as for instance a library (ISAPI) or a program that can run independently (CGI) and which makes available the server functions with application character.

In other detailed aspects, the code generated by the software module contains script routines, such as Java-Script routines, that can be interpreted by the browser and site to be presented in the browser by the software module is generated according to the CSS standard.

In another aspect, the invention relates to a data carrier or computer readable medium having program code instructions for performing a method of creating a user interface for a standard application in the window of a browser that runs on a personal computer workstation of a computer network. As used herein the data carried may comprise any kind of computer memory such as conventional hard drives, CD-ROMS, nonvolatile ROM and RAM. The standard application runs on a server connected to the computer network and at least one user works with the standard application from the personal computer workstation over the computer network. The standard application can be serviced by means of a user interface and work results from the standard application can be returned through the output fields of the user interface. The method includes presenting separate components of the user interface of the standard application in the browser of the personal computer workstation, by converting the state and the function of the separate components into standard code that can be interpreted by the browser and transferring to the standard application in the requested format the data entered by the user and returned by the browser.

These and other aspects and advantages of the invention will become apparent from the following detailed description and the accompanying drawings which illustrate by way of example the features of the invention.

### DETAILED DESCRIPTION OF THE PREFERRED EMBODIMENTS

In the implementation of the method according to the invention, customary code that is normally used in the transfer protocols of the computer network is applied on the server side in order to present in the browser the site with the user interface. Normally, the computer network is the Internet and the user interface will be implemented in HTML or XML code in such a way that for the user sitting at the personal computer workstation the user interface of the server called by the user looks like a normal Internet site presented in the browser.

As used herein, a “standard application” is any ready and functional software, which for example is installed on the server or runs on the server only. This can be a classical word processing program, a database program, or also proprietary software. Also control software and management programs as well as all other theoretical applications can be considered. By integrating the software module of the present invention into the standard application, e.g. a standard word processing program or a table calculation program, these programs can be presented in a Web browser with only a marginal change in the layout of the user interface and without the need of special software at the side of the personal computer workstation. This permits the remotely controlled servicing of all programs equipped with the software module. The software module is built in the source code of the standard application simply as a callable function or an object that can be instantiated. This requires conceivably little effort on the part of the programmer of the standard application. On the other side, the user can take advantage of the possibility for remote control without the need to buy expensive additional software or to undertake laborious installation changes in the system. On the Internet, the user interface appears to the user as a normal Internet site with the usual layout of the standard application.

In this way it is possible for instance to equip a branch software with a software module, which allows the user to run also from a private personal computer at home the software normally used at the work place. It is also possible on the basis of the present invention to use remotely control software over the Internet. So for instance the control software of a telephone facility can be equipped with the software module so that the service technician can use over the Internet the software installed for instance on the computer of the provider and perform the necessary adjustments.

In a preferred implementation of the invention, the components of the user interface are list boxes, input fields and output fields, whereby, of course in the framework of the limits imposed by the resolution of the monitor, practically almost any number of different components can be presented. Components can be all functional elements, which are shown on the user interface of the standard application. As a rule, these are particularly buttons, also press buttons that can be activated by a mouse to initiate an action, text input fields, text output fields, and list boxes. However, other components that can be placed on the user interface are possible.

Normally, the software module recognizes all components and converts them in the selected code, e.g. HTML code. In the case of a confirmation field, a so-called check box, the size and the visible form of the confirmation field as well as the anticipated, respectively the possible, user input can be transferred. Unknown or unidentifiable components are interpreted and transferred as graphic. These can be for instance a GIF file or a JPG file that can be quickly transferred. Then the browser transfers to the server the user input whose type it can not foresee because the object is unknown. The software module transfers the data to the standard application along with the type and the content of the input as well as the coordinates where this has happened. In this way it is possible in most cases to present in the browser unknown objects and the functionality can be preserved despite the lack of recognition.

From the point of view of the personal computer workstation the software module is a normal server from where sites in the predefined format are transferred. This can for instance be an HTML-coded site or an XML-coded site. Preferably, the software module investigates the position of the separate components of the user interface of the standard application. The software module calls a copy of this user interface and saves the position of the found components in a buffer. Then from the positions obtained in this way a pattern can be created with whose help the equivalents of the components that are presented in the browser are arranged in such a way that their presentation in the browser is identical or at least similar to the layout of the actual user interface.

Preferably, in order to create the operating interface, the copy of the user interface of the standard application is investigated by using routines. This can be easily done by using available routines, which are called for instance also for refreshing the computer screen after a change of window or for activating a screen saver. Then with the saved result of this call, the code that is necessary to graphically present the components in the browser can be generated. When the user makes an entry on the version of the user interface that is presented in the browser, this entry is transferred to the server through the computer network where the software module assigns the components belonging to this entry. This assignment of the data to the components can be done, for instance by using operating system routines. Along with the position and the type of the separate component it is also possible to obtain further information about the components. For instance, in the case of a text field, the size, color, and also the type face, of the font size of the presented text can be investigated and then transferred to the browser so that the layout of the browser presentation can be made to conform furthermore to the layout of the user interface.

Equipping the standard application with the software module allows for the generation of a site that can be presented in a browser, but it also has the disadvantage that in this way no actual network capability of the server is created. Therefore, in order to install any operating system on the server, an additional module should take over all administrative tasks of the network system. In amore advantageous implementation of the method, the server is supplied with management software, which for instance “runs” during the operation of the server and therefore is active. This management software can—at the user's request and in his or her browser—start a desired standard application of those that are at the disposal of the server and organize the transfer between the server and the personal computer workstation.

To the possible tasks of this management software, which can be part of the operating system as a so-called “layer” within the application level, belong the management of the access rights and the addresses of the callable programs as well as the organization and management of a multitasking operation. In this way the first user can, for instance call the standard application A. Then the management software starts on the server a copy of this standard application with which the first user can then work. If now—while the first user is still working—a second user wishes to access the same standard application A, the management software organizes the start of another copy, with which the second user can work.

Alternatively, it is possible to install on the server a management software, which can be called from other servers—over the data processing network—as a library (ISAPI) or as an independently running program (CGI). In this case, the networking capability is realized through a client-server application, through which another machine on the data processing network partially supplies the server functions and partially calls them.

The transfer of the menu items of the standard application is difficult with the method used in the present invention because these dynamic elements cannot be converted in a simple way into a suitable format for presenting the standard components. That is why it is preferred that the software module transform the menu items with the menu points of the standard application into a form that can be interpreted by the browser. This means that for instance the software module creates program code to generate the menu items in the browser window where it can be converted into an executable code by an interpreter built in the browser.

The script program can be in particular a Java-Script program, whereby of course also all other languages that can be interpreted by the browser, as for instance VB-Script (Visual Basic Script), can be considered. Using a scripting program it is easy to convert complex menu and submenu structures even when, as for instance in the case of the Microsoft Office family, the menus can change by changing the menu items themselves or their color depending on the task the program is used for. Also other functional areas of the user interface can be converted in this way into code that can be easily transferred and presented.

Particularly a small applet can also be considered a script program. This method is particularly suitable when it can produce program code that is as short as possible. As an alternative to this method, the menu can also be converted into separate graphical components that can be interpreted by the browser, as for instance into a number of buttons. This possibility is particularly suitable for menus with little menu items because otherwise the buttons cannot be drawn on the screen of the personal computer workstation without they or the surface necessary for presenting the user interface of the standard application becoming too small.

In another possible implementation of the method according to the present invention, the site that is presented in the browser is generated with a user interface from the software module according to the Cascading Style Sheets (CSS). This method can be used for presenting user interfaces in a Web browser. However, its use can also be limited to the Intranet. Therefore, it is possible for instance to refrain from using expensive network software in small work groups and instead call over the Intranet from the machine of the co-worker the software that is currently needed, as for example a branch solution, search programs for databases or CD-ROMs, or similar products.

In conclusion, the present invention refers not only to the method described above but also to the software with program code means that is necessary for the realization of the possible implementations of the method. The software is therefore built essentially from the software module, which has to be embedded in the standard application. Additionally, the management software can be installed and run on the server in one of the forms described above. On the user side, only a Web browser has to be available, which nowadays is available almost on every computer.

It will be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. A method for creating a user interface for a standard application in the window of a browser that runs on a personal computer workstation of a computer network whereby the standard application runs on a server connected to the computer network and at least one user works with the standard application from the personal computer workstation over the computer network wherein the standard application can be serviced by means of a user interface and work results from the standard application can be returned through the output fields of the user interface; said method comprising:
presenting separate components of the user interface of the standard application in the browser of the personal computer workstation, by converting the state and the function of the separate components into standard code that can be interpreted by the browser and transferring to the standard application in the requested format the data entered by the user and returned by the browser.

2. The method of claim 1 wherein the components include list boxes, input fields and/or output fields.

3. The method of claim 1 further comprising:
interpreting as graphic the components not recognized;
presenting in the browser window the information for drawing the corresponding graphical components; and
returning to the server the information about the user input corresponding to the graphical components.

4. The method of claim 1 wherein the standard code comprises HTML code.

5. The method of claim 1 wherein the standard code comprises XML code.

6. The method of claim 1 wherein along with the coordinates of the components on the user interface of the standard application also their size, color, and in the case of text components also the type face and font size are investigated and transferred to the browser.

7. The method of claim 1 further comprising:
investigating the coordinates of the position of every component on the user interface; and
on the basis of these coordinates drawing the components in the browser in a manner that is identical or similar to their positioning on the user interface of the standard application.

8. The method of claim 1 further comprising:
investigating the components of the user interface and their positioning on a copy of the user interface of the standard application; and
generating code that is needed in order to draw in the browser such components that are identical or similar to the investigated components.

9. The method of claim 1 wherein the data returned by the browser are assigned to the corresponding components.

10. The method of claim 1 wherein the assignment of the data to the components is done by operating system routines.

11. The method of claim 1 wherein the server runs management software, which—on request by the user through the browser—starts a desired standard application from among the standard applications available on the server and organizes and manages the transfer between the server and the personal computer workstation.

12. The method of claim 1 wherein the server has management software installed, which can be called by other servers either directly or through a suitable interface as for instance a library (ISAPI) or a program that can run independently (CGI) and which makes available the server functions with application character.

13. The method of claim 11 wherein the management software checks the access rights of the users when it processes the incoming requests.

14. The method of claim 11 wherein in order to build a network capability when several requests for a standard application have to be processed, the management software starts once the standard application for each request.

15. The method of claim 11 wherein the code generated contains script routines that can be interpreted by the browser.

16. The method of claim 15 wherein the script routines are Java-Script routines.

17. The method of claim 1 wherein the site to be presented in the browser by the software module is generated according to the CSS standard.

18. A computer readable medium having program code instructions for performing a method of creating a user interface for a standard application in the window of a browser that runs on a personal computer workstation of a computer network whereby the standard application runs on a server connected to the computer network and at least one user works with the standard application from the personal computer workstation over the computer network wherein the standard application can be serviced by means of a user interface and work results from the standard application can be returned through the output fields of the user interface; said method comprising:
presenting separate components of the user interface of the standard application in the browser of the personal computer workstation, by converting the state and the function of the separate components into standard code that can be interpreted by the browser and transferring to the standard application in the requested format the data entered by the user and returned by the browser.

19. The computer readable medium of claim 18 wherein the program code instructions further include those instruction associated with the standard application.

20. The computer readable medium of claim 18 wherein the program code instructions further include those instruction associated with a server management software.

21. A data processing network comprising:
at least one workstation having a browser installed;
at least one server connected to the workstation, the server adapted to run a standard application wherein the standard application can be serviced by means of a user interface and work results from the standard application can be returned through the output fields of the user interface, the standard application having a software module integrated therein, the software module adapted to present separate components of the user interface of the standard application in the browser of the personal computer workstation by converting the state and the function of the separate components into standard code that can be interpreted by the browser and transfer to the standard application in the requested format the data entered by the user and returned by the browser.
